(19) United States
(12) Patent Application Publication
(10) Pub. No.: US 2021/0197624 A1
(43) Pub. Date: Jul. 1, 2021

(54) TIRE

(71) Applicant: Sumitomo Rubber Industries, Ltd., Hyogo (JP)

(72) Inventor: Yutaro INADA, Kobe-shi (JP)

(73) Assignee: Sumitomo Rubber Industries, Ltd., Hyogo (JP)

(21) Appl. No.: 17/107,105

(22) Filed: Nov. 30, 2020

(30) Foreign Application Priority Data
Dec. 25, 2019 (JP) 2019-234858

(51) Int. Cl. B60C 11/13

(52) U.S. Cl. CPC B60C 11/1392

(57) ABSTRACT

A tire includes a tread portion bound with an intended tire rotational direction. The tread portion is provided a plurality of blocks. Each of the blocks includes a first ground contact edge, which is a ground contact edge on a heel side in the tire rotational direction, and a second ground contact edge, which is the ground contact edge on a toe side in the tire rotational direction. A second tire radius which is a tire radius at the second ground contact edge is larger than a first tire radius which is the tire radius at the first ground contact edge.

### TECHNICAL FIELD

The present invention relates to a tire having a plurality of blocks formed in a tread portion bound with an intended tire rotational direction.

### BACKGROUND ART

Conventionally, a tire with a tread portion bound with an intended tire rotational direction has been known. For example, the following Patent Literature 1 has proposed a tire that achieves both wear resistance and wet grip performance by keeping a ground contacting surface shape index in a certain range.

### PRIOR ART DOCUMENT

### Patent Document

### [Patent Document 1]

Unexamined Japanese Patent Application No, 2019-093830

### SUMMARY OF THE INVENTION

### Problems to be Solved by the Invention

However, in the tire of Patent Literature 1, a ground contact pressure on the heel side in the tire rotational direction is locally increased, therefore, a difference may be caused in the ground contact pressure between the heel side and the toe side in the tire rotational direction, which is a cause of decrease in frictional force. Therefore, there has been a demand for further improvements in traction performance, which is affected by frictional force.

The present invention was made in view of the above, and a primary object thereof is to provide a tire capable of improving the traction performance by making the ground contact pressure uniform during tire rotation.

### Means for Solving the Problems

The present invention is a tire including a tread portion bound with an intended tire rotational direction, wherein the tread portion is provided with a plurality of blocks, each of the blocks includes a first ground contact edge, which is a ground contact edge on a heel side in the tire rotational direction, and a second ground contact edge, which is the ground contact edge on a toe side in the tire rotational direction, and a second tire radius which is a tire radius at the second ground contact edge is larger than a first tire radius which is the tire radius at the first ground contact edge.

In the pneumatic tire according to the present invention, it is preferred that the second tire radius is lamer than the first tire radius by 0.3 mm or more and 1.5 mm or less.

In the pneumatic tire according to the present invention, it is preferred that each of the blocks has a side wall extending inward in a tire radial direction from the second ground contact edge, and the side wall is parallel to a tire radial direction reference line which is a radial linear line passing through the first ground contact edge.

In the pneumatic tire according to the present invention, it is preferred that each of the blocks includes a protruding portion protruding radially outward from a reference plane defined by the first tire radius, the side wall is provided in the protruding portion, and the reference plane is a plane passing through the first ground contact edge and an imaginary line on a side surface on the toe side of the block, the imaginary line being arranged at a distance equal to the first tire radius from a tire center.

In the pneumatic tire according to the present invention, it is preferred that each of the blocks has a ground contacting surface extending in an arc shape in a tire circumferential direction between the first ground contact edge and the second ground contact edge, and a radius of curvature of the ground contacting surface is 0.5 times or more and 2.0 times or less the first tire radius.

In the pneumatic tire according to the present invention, it is preferred that each of the blocks has a rubber hardness of 55 degrees or more and 70 degrees or less.

In the pneumatic tire according to the present invention, it is preferred that a pitch length of the blocks adjacent to each other in the tire circumferential direction is 25 mm or more and 50 mm or less.

In the pneumatic tire according to the present invention, it is preferred that the tread portion includes a block row in which 50 to 80 blocks are arranged in a tire circumferential direction.

### Effects of the Invention

In the pneumatic tire according to the present invention, each of the blocks includes the first ground contact edge which is the ground contact edge on the heel side in the tire rotational direction and the second ground contact edge which is the ground contact edge on the toe side in the tire rotational direction, and the second tire radius which is the tire radius at the second ground contact edge is larger than the first tire radius which is the tire radius at the first ground contact edge. In the tire configured as such, a local change in the ground contact pressure during rotation is suppressed, therefore, the ground contact pressure at the first ground contact edge and the ground contact pressure at the second ground contact edge can be uniformized. Thereby, in the tire of the present invention, it is possible that the traction performance is improved.

### BRIEF DESCRIPTION OF THE DRAWINGS

FIG. 1 a schematic side view showing one embodiment of the tire of the present invention.

FIG. 2 an enlarged view of part (A) of FIG. 1.

FIG. 3 an enlarged view of part (A) of another embodiment.

### MODE FOR CARRYING OUT THE INVENTION

An embodiment of the present invention will now be described in conjunction with accompanying drawings.

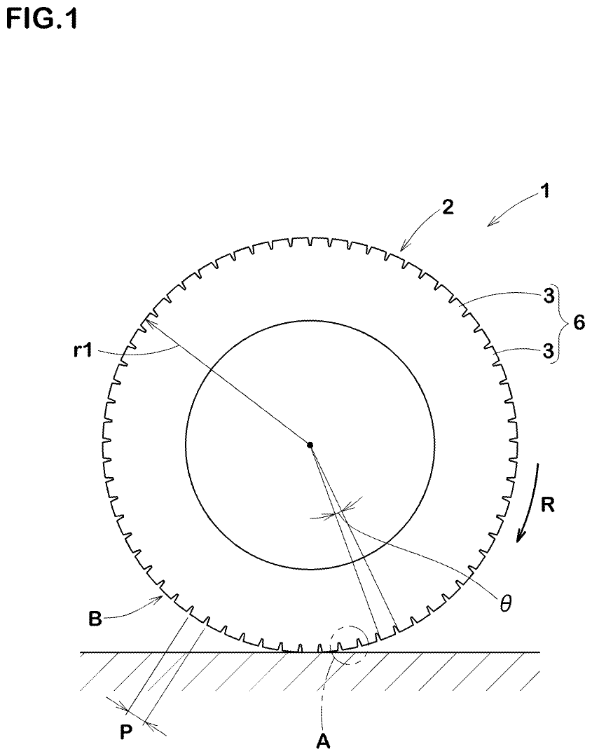

FIG. 1 is a schematic side view of a tire 1 of the present embodiment. As shown in FIG. 1, the tire 1 of the present embodiment is suitably used as a pneumatic tire to be mounted on a 4 WD vehicle and the like capable of running on rough terrain. The tire 1 is not limited to such an embodiment and can be used as appropriate for a variety of tires, such as pneumatic tires to be mounted on motorcycles, passenger cars, heavy load vehicles, and the like, and non-pneumatic tires that are not filled with pressurized air inside the tire, for example.

The Tire 1 in the present embodiment has a tread portion 2 bound with an intended tire rotational direction (R). A plurality of blocks 3 are formed in the tread portion 2 of the present embodiment. The tire 1 having the tread portion 2 configured as such is suitable for running on rough terrain, such as snowy roads, muddy roads, and the like.

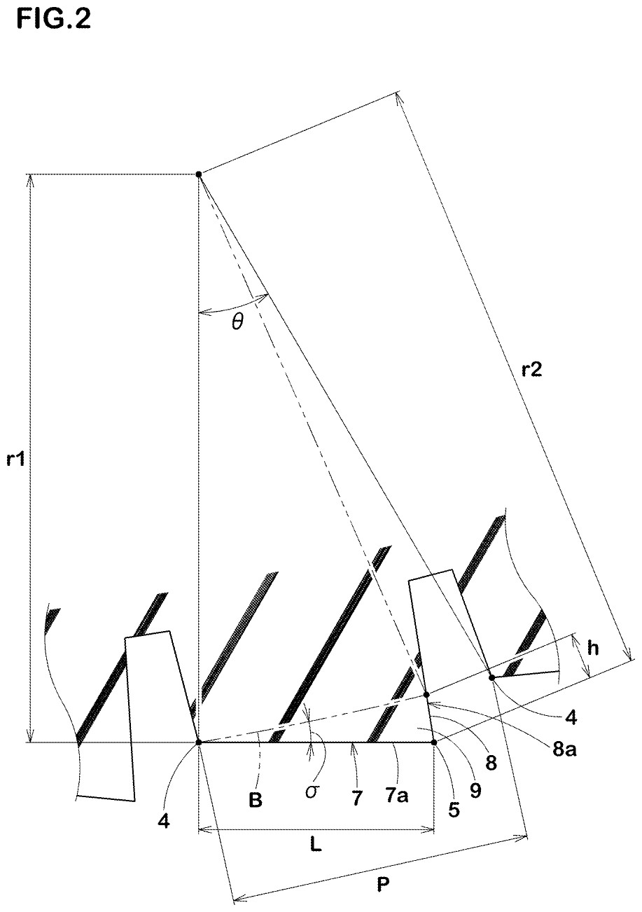

FIG. 2 is an enlarged view of part (A) of FIG. 1. As shown in FIG. 2, each of the blocks 3 of the present embodiment includes a first ground contact edge 4, which is a ground contact edge on the heel side in the tire rotational direction (R), and a second ground contact edge 5, which is the ground contact edge on the toe side in the tire rotational direction (R). Here, the ground contact edges of the blocks 3 are edges in a tire circumferential direction of the blocks 3, and when the edges extend in a tire axial direction, the ground contact edges are formed in a linear shape, and when the edges extend obliquely with respect to the tire axial direction, the ground contact edges are formed in a dot shape.

In the present embodiment, a second tire radius (r2), which is the tire radius at the second ground contact edge 5, is larger than a first tire radius (r1), which is the tire radius at the first ground contact edge 4. In the tire 1 configured as such, a local change in the ground contact pressure during rotation is suppressed, therefore, it is possible that the ground contact pressure at the first ground contact edge 4 and the ground contact pressure at the second ground contact edge 5 are made uniform. Thereby, in the tire 1 of the present embodiment, it is possible that the traction performance is improved.

As a more preferred embodiment, the second tire radius (r2) is greater than the first tire radius (r1) by 0.3 mm or more and 1.5 mm or less. In other words; it is preferred that a difference (h) between the second tire radius (r2) and the first tire radius (r1) is 0.3 mm or more and 1.5 mm or less. When the difference (h) between the second tire radius (r2) and the first tire radius (r1) is 0.3 mm or more, the locally high ground contact pressure at the first ground contact edge 4 can be suppressed. When the difference (h) between the second tire radius (r2) and the first tire radius (r1) is 1.5 mm or less, the locally high ground contact pressure at the second ground contact edge 5 can be suppressed.

As shown in FIG. 1, it is preferred that the tread portion 2 includes a block row 6 in which 50 to 80 blocks 3 are arranged in the tire circumferential direction. The tread portion 2, which includes the block row 6 configured as such, can exert excellent rough terrain running performance.

When the number of the blocks 3 included in the block row 6 is N, a pitch angle θ of the blocks 3 adjacent to each other in the tire circumferential direction can be expressed by the following Expression 1.

θ=360/N (Expression 1)

Here, if the block row 6 has more than one pitch angle θ, the pitch angle θ expressed in Expression 1 is the average pitch angle θ of them.

Further, in this case, a pitch length (P) of the blocks 3 adjacent to each other in the tire circumferential direction on a reference plane (B), which is defined by the first tire radius (r1), can be expressed by the following Expression 2. The reference plane (B) is a plane passing through the first ground contacting edge and an imaginary line on a wall surface (8a), which is a side surface on the toe side of the block, arranged at a distance from the tire center equal to the first tire radius (r1).

P≈2·r1·sin θ/2 (Expression 2)

In the tread portion 2 of the present embodiment, the pitch length (P) of the blocks 3 adjacent to each other in the tire circumferential direction is 25 mm or more and 50 mm or less. When the pitch length (P) is 25 mm or more, the rigidity of each of the blocks 3 can be improved. When the pitch length (P) is 50 mm or less, excellent rough terrain running performance can be maintained.

As shown in FIG. 2, each of the blocks 3 of the present embodiment has a ground contacting surface 7 which extends in the tire circumferential direction between the first ground contact edge 4 and the second ground contact edge 5 and a side wall 8 which extends inward in a tire radial direction from the second ground contact edge 5. The ground contacting surface 7 includes a linear section (7a) extending linearly between the first ground contact edge 4 and the second ground contact edge 5, for example. The side wall 8 is provided on the wall surface (8a) arranged on the toe side in the tire rotational direction (R) and including the second ground contact edge 5, for example. The side wall 8 may be firmed as the wall surface (8a) or may be a line portion (8h) provided on the wall surface (8a), for example.

Each of the blocks 3 of the present embodiment includes a protruding portion 9 protruding radially outward from the reference plane (B) defined by the first tire radius (r1). The ground contacting surface 7 of the present embodiment is provided in the protruding portion 9. It is preferred that a length (L) in the tire circumferential direction of the ground contacting surface 7 is smaller than the pitch length (P) of the blocks 3. Here, the length (L) in the tire circumferential direction of the ground contacting surface 7 is the length measured along the ground contacting surface 7.

It is preferred that the length (1) in the tire circumferential direction of the ground contacting surface 7 in the present embodiment is 20 mm or more and 40 mm or less. When the length (L) of the ground contacting surface 7 is 20 mm or more, the rigidity of each of the blocks 3 can be improved. When the length (L) of the ground contacting surface 7 is 40 mm or less, excellent rough terrain running performance can be maintained.

It is preferred that the side wall 8 is formed at least in the protruding portion 9. The side wall 8 of the present embodiment continuously extends from the protruding portion 9 to the radially inner side of the blocks 3. The side wall 8 configured as such is helpful for improving the frictional force during acceleration.

A height (h) of the protruding portion 9 in the present embodiment is the difference (h) between the second tire radius (r2) and the first tire radius (r1). The height (h) of the protruding portion 9 can be expressed by the following Expression 3 by an angle σ between the ground contacting surface 7 and the reference plane (B) and the length (L) of the ground contacting surface 7.

h=L·sin σ (Expression 3)

Here, it is preferred that the angle σ between the ground contacting surface 7 and the reference plane (B) satisfies the following Expression 4.

σ<180/N (Expression 4)

The blocks 3 each having the protruding portion 9 configured as such can uniformize the ground contact pressure at the first ground contact edge 4 and the ground contact pressure at the second ground contact edge 5, which is helpful for improving the traction performance of the tire 1.

As the blocks 3 of the present embodiment, those having a rubber hardness of 55 degrees or more and 70 degrees or less are suitably used. Here, the rubber hardness is the hardness measured by a type-A durometer in an environment of 23 degrees Celsius in accordance with Japanese Industrial Standard JIS-K6253. The blocks 3 configured as such can suppress partial chipping while improving frictional force.

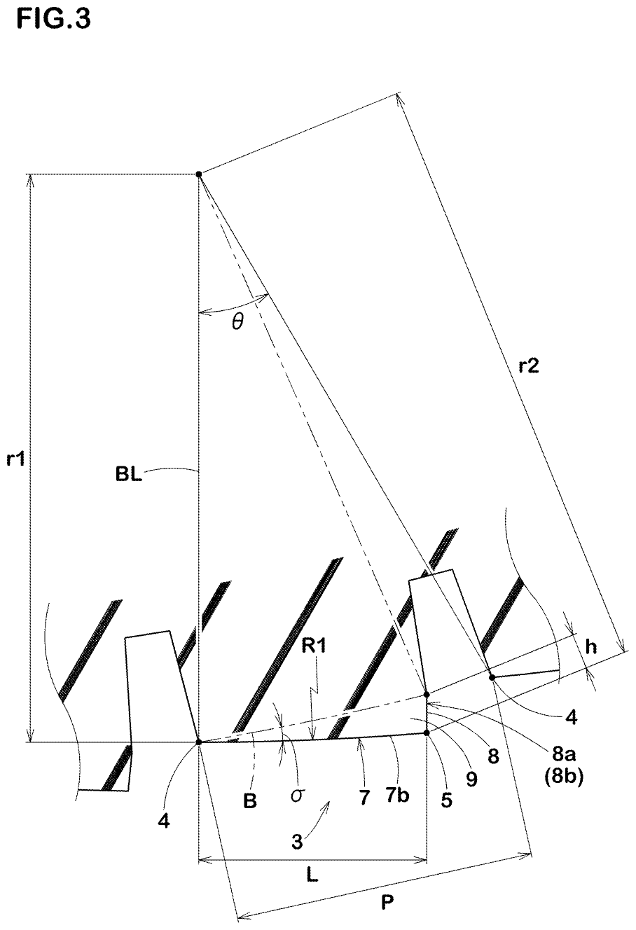

FIG. 3 is an enlarged view of the part (A) according to another embodiment. As shown in FIG. 3, each of the blocks 3 in this embodiment has the ground contacting surface 7 extending in an arc shape in the tire circumferential direction between the first ground contact edge 4 and the second ground contact edge 5. The ground contacting surface 7 includes an arc portion (7b) extending in an arc shape between the first ground contact edge 4 and the second ground contact edge 5, for example. The ground contacting surface 7 configured as such suppresses the local increase in the ground contact pressure at the second ground contact edge 5, therefore, the ground contact pressure of the ground contacting surface 7 can be uniformized.

It is preferred that a radius of curvature (R1) of the ground contacting surface 7 is 0.5 times or more and 2.0 times or less the first tire radius (r1). Here, the radius of curvature (R1) of the ground contacting surface 7 is the value measured in a cross section taken along the tire circumferential direction. When the radius of curvature (R1) is 0.5 times or more the first tire radius (r1), the local increase in the ground contact pressure of the ground contacting surface 7 can be suppressed. When the radius of curvature (R1) is 2.0 times or less the first tire radius (r1), the local increase in the ground contact pressure at the second ground contact edge 5 can be suppressed.

It is preferred that the length (L) in the tire circumferential direction of the ground contacting surface 7 in the present embodiment is 20 mm or more and 40 mm or less. When the length (L) of the ground contacting surface 7 is 20 mm or more, the rigidity of each of the blocks 3 can be improved. When the length (L) of the ground contacting surface 7 is 40 mm air less, excellent rough terrain running performance can be maintained.

Each of the blocks 3 of this embodiment is provided with the side wall 8 extending radially inward from the second ground contact edge 5. It is preferred that the side wall 8 is parallel to a tire radial direction reference line (BL) which is a radial linear line passing through the first ground contact edge 4. Each of the blocks 3 configured as such suppresses the chipping of the second ground contact edge 5, which tends to occur during deceleration, therefore, the traction performance can be maintained high for a long period of time.

Each of the blocks 3 of this embodiment includes the protruding portion 9 protruding radially outward from the reference plane (B) defined by the first tire radius (r1). The ground contacting surface 7 and the side wall 8 of this embodiment are formed in the protruding portion 9.

The height (h) of the protruding portion 9 of this embodiment can be expressed by the following Expression 5 by the angle c which is defined by the Expression 4 and the length (L) of the ground contacting surface 7.

h=L·tan σ (Expression 5)

Each of the blocks 3 having the protruding portion 9 configured as such can uniformize the ground contact pressure at the first ground contact edge 4 and the ground contact pressure at the second ground contact edge 5, which is helpful for improving the traction performance of tire 1.

While detailed description has been made of an especially preferred embodiment of the present invention, the present invention can be embodied in various forms without being limited to the illustrated embodiment.

### Example (Working Example)

As the tire having the blocks of FIG. 1, Example 1 having the blocks of FIG. 2 and Example 2 having the blocks of FIG. 3 were made by way of test: As Reference, a tire having no protruding portion was made by way of test. The test tires were tested for the traction performance, braking performance and block chipping. Common specifications and test methods were as follows.

### <Common Specification>

Tire size: 265/65R8

Tire rim size: 18×7.5J

Tire air pressure: 230 kPa.

Tire load rate: 80%

### <Traction Performance>

By using a bench testing machine, the traction performance of the test tires during acceleration was measured under a dry road condition and a wet road condition. The results are indicated by an index based on the Reference being 100, wherein the larger the numerical value, the larger the frictional force is, which shows more excellent traction performance.

### <Braking Performance>

By using a bench testing machine, the braking performance of the test tires during deceleration was measured under a dry road surface condition and a wet road surface condition. The results are indicated by an index based on the Reference being 100, wherein the larger the numerical value, the larger the frictional force is, which shows more excellent braking performance.

### <Block Chipping>

After the braking performance test under the dry road surface condition was repeated 10 times, it was confirmed whether or not the blocks were chipped. The results are represented by the presence or absence of the chipping, wherein the absence of chipping indicates that the traction performance and the braking performance of the initial stage be maintained for a long period of time.

The test results are shown in Table 1.

TABLE 1

| | Reference | Example 1 | Example 2 |
|---|---|---|---|
| Traction performance under | 100 | 103 | 103 |
| dry road condition | | | |
| Braking performance under | 100 | 100 | 100 |
| dry road condition | | | |
| Traction performance under | 100 | 103 | 103 |
| wet road condition | | | |
| Braking performance under | 100 | 100 | 100 |
| wet road condition | | | |
| Presence or Absence of Block | Absence | Presence | Absence |
| chipping | | | |

From the test results, it was confirmed that the tires in the Examples had excellent traction performance compared with the tires in the Reference. Therefore, it was confirmed that the fraction performance was improved in the tires in the Examples compared with the tires in the Reference. Further, it was confirmed that more excellent traction performance can be maintained for a long period of time in the tires in the Example 2 compared with the tires in the Example 1.

### DESCRIPTION OF REFERENCE SIGNS

1 tire
2 tread portion
3 block
4 first ground contact edge
5 second ground contact edge

1. A tire comprising a tread portion hound with an intended tire rotational direction, wherein
the tread portion is provided with a plurality of blocks,
each of the blocks includes a first ground contact edge, which is a ground contact edge on a heel side in the tire rotational direction, and a second ground contact edge, which is the ground contact edge on a toe side in the tire rotational direction, and
a second tire radius which is a tire radius at the second ground contact edge is larger than a first tire radius which is the tire radius at the first ground contact edge.

2. The tire according to claim 1, wherein the second tire radius is larger than the first tire radius by 0.3 mm or more and 1.5 mm or less.

3. The tire according to claim 1, wherein
each of the blocks has a side wall extending inward in a tire radial direction from the second ground contact edge, and
the side wall is parallel to a tire radial direction reference line which is a radial linear line passing through the first ground contact edge.

4. The tire according to claim 3, wherein
each of the blocks includes a protruding portion protruding radially outward from a reference plane defined by the first tire radius,
the side wall is provided in the protruding portion, and
the reference plane is a plane passing through the first ground contact edge and an imaginary line on a side surface on the toe side of the block, the imaginary line being arranged at a distance equal to the first tire radius from a tire center.

5. The tire according to claim 1, wherein
each of the blocks has a ground contacting surface extending in an arc shape in a tire circumferential direction between the first ground contact edge and the second ground contact edge, and
a radius of curvature of the ground contacting surface is 0.5 times or more and 2.0 times or less the first tire radius.

6. The tire according to claim 1, wherein each of the blocks has a rubber hardness of 55 degrees or more and 70 degrees or less.

7. The tire according to claim 5, wherein a pitch length of the blocks adjacent to each other in the tire circumferential direction is 25 mm or more and 50 mm or less.

8. The tire according to claim 1, wherein the tread portion includes a block row in which 50 to 80 blocks are arranged in a tire circumferential direction.

9. The tire according to claim 7, wherein a length in the tire circumferential direction of the ground contacting surface is smaller than the pitch length of the blocks.

10. The tire according to claim 9, wherein the length in the tire circumferential direction of the ground contacting surface is 20 mm or more and 40 mm or less.

11. The tire according to claim 4, wherein
the tread portion includes a block row in which 50 to 80 blocks are arranged in the tire circumferential direction,
in each of the blocks,
a height of the protruding portion is expressed by following Expression 3,
h=L·sin σ (Expression 3)
the angle σ satisfies following Expression 4,
σ<180/N (Expression 4)
wherein
h is the height of the protruding portion,
σ is the angle between a ground contacting surface and the reference plane,
L is the length in the tire circumferential direction of the of the ground contacting surface, and
N is the number of the blocks included in the block row.

12. The tire according to claim 6, wherein
the rubber hardness is the hardness measured by a type-A durometer in an environment of 23 degrees Celsius.
